(19) United States
(12) Patent Application Publication
(10) Pub. No.: US 2025/0355111 A1
(43) Pub. Date: Nov. 20, 2025

(54) KICK SENSOR, VEHICLE, AND METHOD OF DETECTING KICK GESTURE

(71) Applicant: Alps Alpine Co., Ltd., , Tokyo (JP)

(72) Inventors: Eiji SAITO, Tokyo (JP); Naoki AKIBA, Tokyo (JP); Ikuyasu MIYAKO, Miyagi-ken (JP); Nobuyasu YAKUWA, Tokyo (JP); Kenji HIKIDA, Miyagi-ken (JP)

(21) Appl. No.: 19/290,842

(22) Filed: Aug. 5, 2025

Related U.S. Application Data
(63) Continuation of application No. PCT/JP2023/045683, filed on Dec. 20, 2023.

(30) Foreign Application Priority Data
Feb. 20, 2023 (JP) 2023-023904

(51) Int. Cl. G01S 13/88; B60R 16/023; G01S 13/50

(52) U.S. Cl. CPC G01S 13/88; B60R 16/0231; G01S 13/50

(57) ABSTRACT

A kick sensor that detects a kick gesture performed by a user, to reduce the occurrence of incorrect detection of gestures other than kick gestures as kick gestures, includes a sensor unit disposed to a vehicle to detect approach and separation of a target object, and a control unit configured to determine motion of the target object based on a detection result of the sensor unit. The control unit calculates a first distance that the target object has moved toward the sensor unit and a second distance that the target object has moved away from the sensor unit, and determines that a kick gesture has been performed when the first distance is within a first distance range, the second distance is within a second distance range, and a first distance ratio obtained by dividing the second distance by the first distance is less than a first threshold value.

### CLAIM OF PRIORITY

This application is a Continuation of International Application No. PCT/JP2023/045683 filed on Dec. 20, 2023, which claims benefit of Japanese Patent Application No. 2023-023904 filed on Feb. 20, 2023. The entire contents of each application noted above are hereby incorporated by reference.

### BACKGROUND OF THE INVENTION

### 1. Field of the Invention

The present invention relates to a kick sensor, a vehicle, and a method of detecting a kick gesture.

### 2. Description of the Related Art

Some of vehicles, such as automotive vehicles, use systems for detecting a kick gesture performed with a user's leg or other parts to open and close the rear door or other doors. Kick sensors that detect a kick gesture performed with a user's leg or other parts are also known (see Japanese Unexamined Patent Application Publication No. 2018-96128, for example).

For such kick sensors, there is a need to reduce incorrect detection that determines gestures other than kick gestures as kick gestures. For example, the technology disclosed in Patent Literature 1 calculates the time elapsed when a sensor output value exceeds a threshold value to detect motion. However, in this method, even if a gesture different from a kick gesture is performed, the gesture may be determined as a kick gesture when the time exceeding the threshold value is the same as that of kick gestures.

An aspect of the present invention provides a kick sensor that detects user's kick gestures with reduced incorrect detection of gestures other than kick gestures as kick gestures.

### SUMMARY OF THE INVENTION

To solve the above-described problem, a kick sensor according to an aspect of the invention includes a sensor unit disposed to a vehicle to detect approach and separation of a target object, and a control unit configured to determine motion of the target object based on a detection result of the sensor unit. The control unit calculates a first distance that the target object has moved toward the sensor unit and a second distance that the target object has moved away from the sensor unit, and determines that a kick gesture has been performed when the first distance is within a first distance range, the second distance is within a second distance range, and a first distance ratio obtained by dividing the second distance by the first distance is less than a first threshold value.

### BRIEF DESCRIPTION OF THE DRAWINGS

FIG. 1 is a diagram illustrating an example system configuration of an in-vehicle system according to an embodiment;

FIG. 2 is a diagram illustrating an overview of processing according to the embodiment;

FIG. 3 is a diagram illustrating an overview of processing according to the embodiment;

FIG. 4 is a diagram illustrating an overview of processing according to the embodiment;

FIG. 5 is a diagram illustrating an overview of processing according to the embodiment;

FIG. 6 is a diagram illustrating an overview of processing according to the embodiment;

FIG. 7 is a diagram illustrating an example hardware configuration of a computer according to the embodiment;

FIG. 8 is a diagram illustrating an example functional configuration of a control unit according to the embodiment;

FIG. 9 is a flowchart illustrating an example of kick gesture detection processing according to the embodiment;

FIG. 10 is a flowchart illustrating an example of feature extraction processing according to the embodiment;

FIG. 11A is a flowchart illustrating an example of distance ratio determination processing according to the embodiment;

FIG. 11B is a flowchart illustrating another example of distance ratio determination processing according to the embodiment;

FIG. 11C is a flowchart illustrating a modified example of distance ratio determination processing according to the embodiment shown in FIG. 11A;

FIG. 11D is a flowchart illustrating a modified example of distance ratio determination processing according to the embodiment shown in FIG. 11B;

FIG. 11E is a flowchart illustrating another example of distance ratio determination processing according to the embodiment; and

FIG. 11F is a flowchart illustrating another example of distance ratio determination processing according to the embodiment.

### DESCRIPTION OF THE PREFERRED EMBODIMENTS

Hereinafter, an embodiment (the embodiment) of the present invention will be described with reference to the attached drawings.

### <System Configuration>

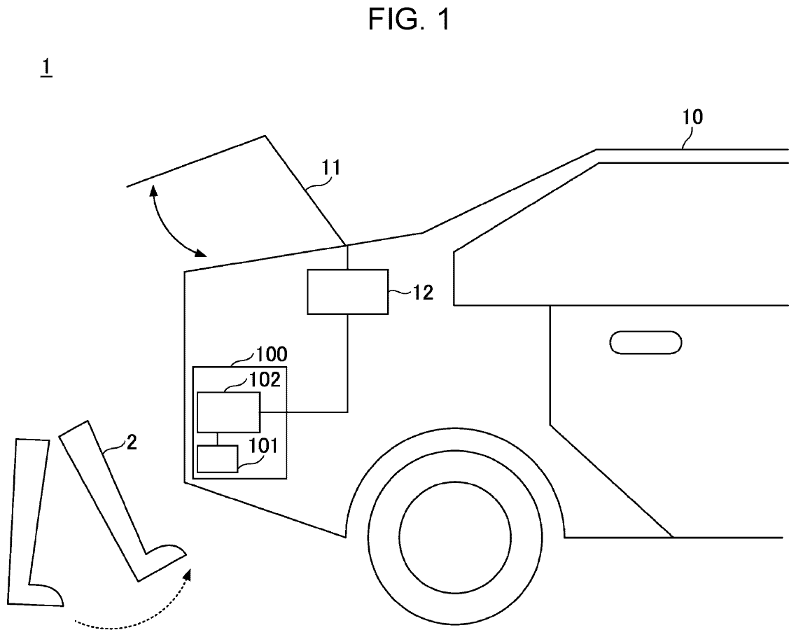

FIG. 1 is a diagram illustrating an example system configuration of an in-vehicle system according to the embodiment. An in-vehicle system 1 detects a kick gesture performed by a user's leg 2 or other like by using a kick sensor 100 that is disposed to a vehicle 10, such as an automobile, to open and close a door of the vehicle 10. In the example illustrated in FIG. 1, the in-vehicle system 1 includes the kick sensor 100 that is disposed at the rear of the vehicle 10 and an electric control unit (ECU) 12 that controls the opening and closing of a rear door (or a trunk) 11.

The kick sensor 100 includes a sensor unit 101 that detects approach or separation of a target object, and a control unit 102 that determines motion of a target object based on a detection result of the sensor unit 101. The sensor unit 101 is, for example, a Doppler radar, and the control unit 102 acquires, based on an output signal from the sensor unit 101, a speed of a target portion (user's leg 2) moving toward the sensor unit 101, and a speed of the target object moving away from the sensor unit 101.

The control unit 102 accumulates the speed of the target object while the target object is moving toward the sensor unit 101 and calculates a distance (hereinafter, referred to as a first distance) that the target object has moved toward the sensor unit 101. Similarly, the control unit 102 accumulates the speed of the target object while the target object is moving away from the sensor unit 101 and calculates a distance (hereinafter, referred to as a second distance) that the target object has moved away from the sensor unit 101.

In addition, the control unit 102 detects whether a kick gesture has been performed by the user's leg 2 or other parts based on the first distance that the target object has moved toward the sensor unit 101, the second distance that the target object has moved away from the sensor unit 101, and a distance ratio between the first distance and the second distance, and outputs the detection result.

The electric control unit 12 opens and closes the rear door 11 or other doors of the vehicle 10 based on the detection result of the kick gesture output from the control unit 102. It should be noted that the system configuration of the in-vehicle system 1 illustrated in FIG. 1 is an example. For example, the control unit 102 of the kick sensor 100 and the electric control unit 12 may be implemented as one ECU. The electric control unit 12 may open and close a door other than the rear door 11 of the vehicle 10 based on a detection result from the kick sensor 100.

The sensor unit 101 is not limited to the Doppler radar for measuring speed, but may also be a pulse radar that measures distance, a frequency modulated continuous wave radar (FM-CW radar), or other radars. In addition, the sensor unit 101 is not limited to the radar, but may be, for example, an ultrasonic sensor that measures distance.

Here, as an example, the following description will be made by using a Doppler radar as the sensor unit 101. The Doppler radar measures speed of a target object, and it is easy to detect whether the target object starts to move toward the sensor unit 101, whether the direction of the movement of the target object is reversed, or other movement. In the following description, the Doppler radar may simply be referred to as a radar.

### <Overview of Processing>

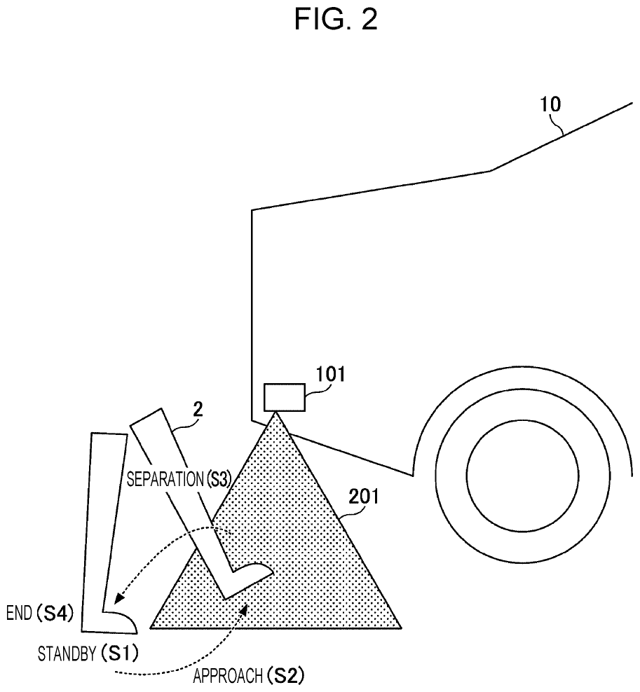

FIGS. 2 to 6 are diagrams illustrating an overview of processing according to the embodiment. As illustrated in FIG. 2, the sensor unit 101 transmits a signal within a detection range 201 of the radar and measures the amplitude of a received signal that is reflected at a target object and received to detect approach and separation of the user's leg 2.

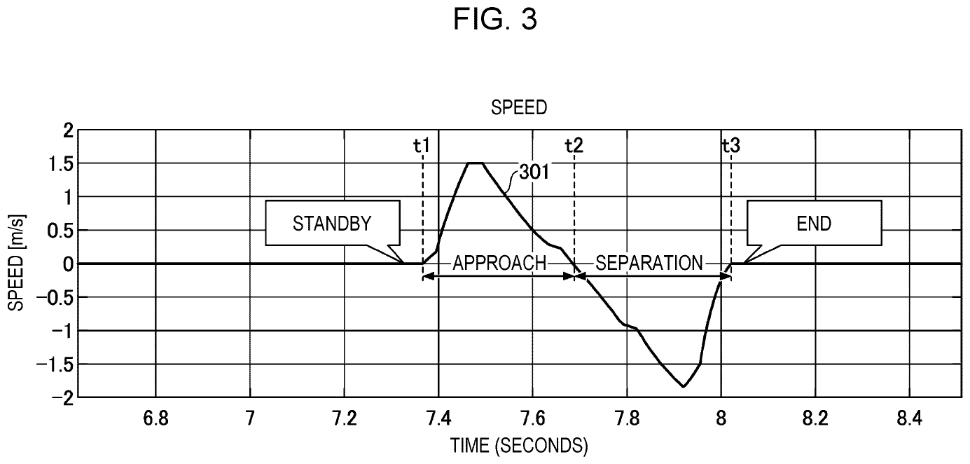

The kick gesture has four states: standby (S1) in which the leg 2 is stationary; approach (S2) in which the leg 2 is moving toward the sensor unit 101; separation (S3) in which the leg 2 is moving away from the sensor unit 101; and end (S4) in which the kick ends and the leg 2 is stationary. When these four states are observed by using the Doppler radar, for example, observation data like that shown in FIG. 3 is obtained.

In FIG. 3, the horizontal axis represents the passage of time, and the vertical axis represents the speed 301 of the target object (user's leg 2). In FIG. 3, the speed 301 shows that the speed 301 takes positive values from time t1 and that the target object is in the approach (S2) state in which the target object is moving toward the sensor unit 101. Then, the speed 301 shows that the speed 301 takes negative values after the speed 301 becomes zero at time t2 and that the target object is in the separation (S3) state in which the target object is moving away from the sensor unit 101. Then, the speed 301 shows that the speed 301 becomes zero at time t3 and that the target object is in the end (S4) state in which the kick gesture has ended.

The control unit 102 calculates, based on speed data of a target object, for example, the data shown in FIG. 3, a first distance, which is a distance that the target object has moved toward the sensor unit 101, and a second distance, which is a distance that the target object has moved away from the sensor unit 101. For example, the control unit 102 calculates the first distance by accumulating the speed of the target object while the target object is moving toward the sensor unit 101, and calculates the second distance by accumulating the speed of the target object while the target object is moving away from the sensor unit 101.

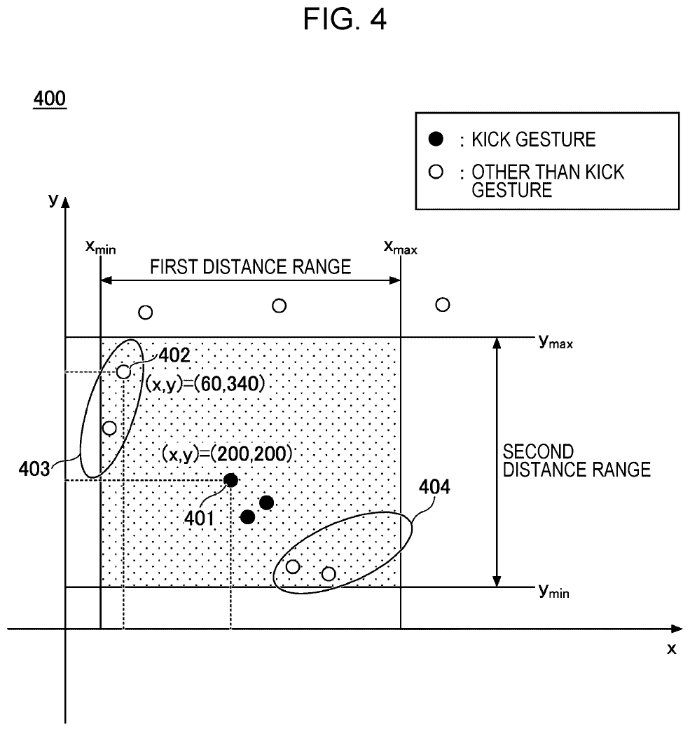

When the first distance calculated by the control unit 102 is x and the second distance is y, and the relationship between the first distance x and the second distance y of a plurality of gestures is plotted on the x and y axes, for example, a graph 400 like that shown in FIG. 4 is obtained. The graph 400 shows an example of data 401 obtained from a kick gesture and data 402 obtained from a gesture other than kick gestures.

Here, the gesture other than the kick gestures may be, for example, a gesture of wiping an area around a bumper of the vehicle 10, a gesture of walking near the bumper, a gesture of bringing an object toward the bumper, a gesture of moving a ball or the like under the bumper, a gesture of spraying water around the bumper, a gesture of unloading luggage from the trunk of the vehicle 10, a gesture of moving legs while the user is in the trunk, a gesture of getting on the vehicle, a gesture of getting off the vehicle, a state in which the vehicle 10 is left in a rainy environment, or the like.

In FIG. 4, the value xₘᵢₙ denotes a lower limit value of the first distance x, and the value xₘₐₓ denotes an upper limit value of the first distance x. The value xₘᵢₙ is a threshold value for excluding gestures in which the first distances x that target objects have moved toward the sensor unit 101 are too small as kick gestures. The value xₘₐₓ is a threshold value for excluding gestures in which the first distances x that target objects have moved toward the sensor unit 101 are too large as kick gestures.

Similarly, the value yₘᵢₙ denotes a lower limit value of the second distance y, and the value yₘₐₓ denotes an upper limit value of the second distance y. The value yₘᵢₙ is a threshold value for excluding gestures in which the second distances y that target objects have moved away from the sensor unit 101 are too small as kick gestures. The value yₘₐₓ is a threshold value for excluding gestures in which the second distances y that target objects have moved away from the sensor unit 101 are too large as kick gestures.

In the example in FIG. 4, the lower limit value xₘᵢₙ of the first distance x is smaller than the lower limit value yₘᵢₙ of the second distance y. When the distance between the vehicle 10 and the user is very close, the user often moves back a little after performing a kick gesture. Accordingly, by setting the lower limit value xₘᵢₙ of the first distance x to a value smaller than the lower limit value yₘᵢₙ of the second distance y, the control unit 102 can accurately detect a kick gesture even when the distance between the vehicle 10 and the user is very close.

The control unit 102 determines that a gesture is not a kick gesture when a calculated first distance x is not within a first distance range from xₘᵢₙ to xₘₐₓ. Similarly, the control unit 102 determines that a gesture is not a kick gesture when a calculated second distance y is not within a second distance range from yₘᵢₙ to yₘₐₓ. With this configuration, the control unit 102 can reduce the occurrence of incorrectly detecting gestures other than kick gestures as kick gestures.

It should be noted that, to account for individual differences, the first distance range and the second distance range need to be set wide and accordingly, it is difficult to sufficiently suppress incorrect detection of gestures other than kick gestures as kick gestures.

Accordingly, in this embodiment, a distance ratio between a first distance that a target object has moved toward the sensor unit 101 and a second distance that the target object has moved away from the sensor unit 101 is used as a feature quantity for detecting a kick gesture.

A person with a long first distance x in a kick gesture also has a long second distance y, and a person with a short first distance x also has a short second distance y. Accordingly, the distance ratio between the first distance x and the second distance y has little individual variation, and the range for determining whether a kick gesture has been performed can be set to a narrow range.

More specifically, the control unit 102 determines that a kick gesture has been performed when a first distance x is within a first distance range, a second distance y is within a second distance range, and a distance ratio between the first distance x and the second distance y is within a predetermined range.

For example, when users perform a kick gesture while moving toward the vehicle 10, many users move their legs from behind their pivot legs, kick upward, and then bring their kicking leg back to the side of their pivot legs. Accordingly, in many cases, the first distances x are greater than the second distances y, and when the second distances y are excessively large compared to the first distances x, it is highly likely that the gestures are not kick gestures.

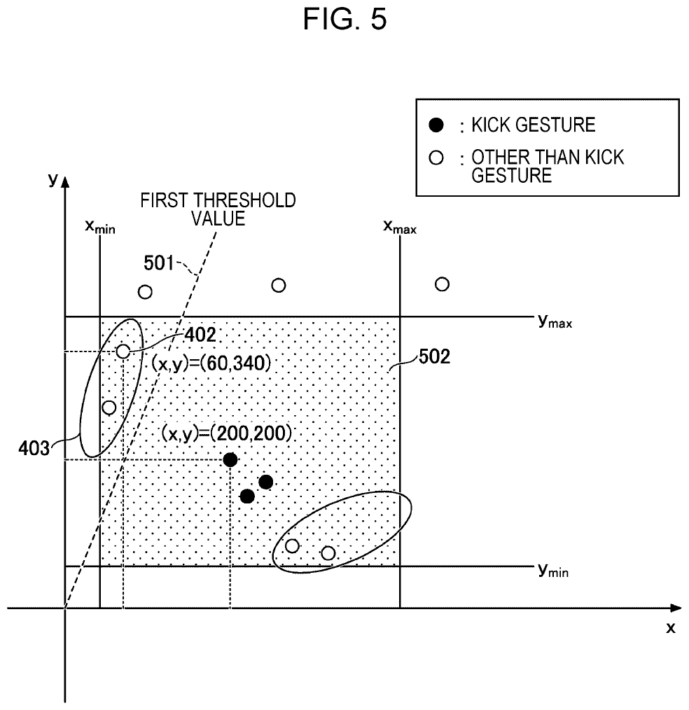

In this embodiment, as illustrated in FIG. 5, a first threshold value 501, which is used to determine whether a first distance ratio obtained by dividing a second distance y by a first distance x means a kick gesture or a gesture other than a kick gesture, is used. For example, the control unit 102 determines that a kick gesture has been performed when a first distance x is within the first distance range, a second distance y is within the second distance range, and a first distance ratio, which is obtained by dividing the second distance y by the first distance x, is less than the first threshold value 501. With this configuration, the control unit 102 can further reduce the occurrence of incorrect determination of data, for example, data 402 obtained by gestures other than kick gestures in the region 403 in FIG. 5 as kick gestures.

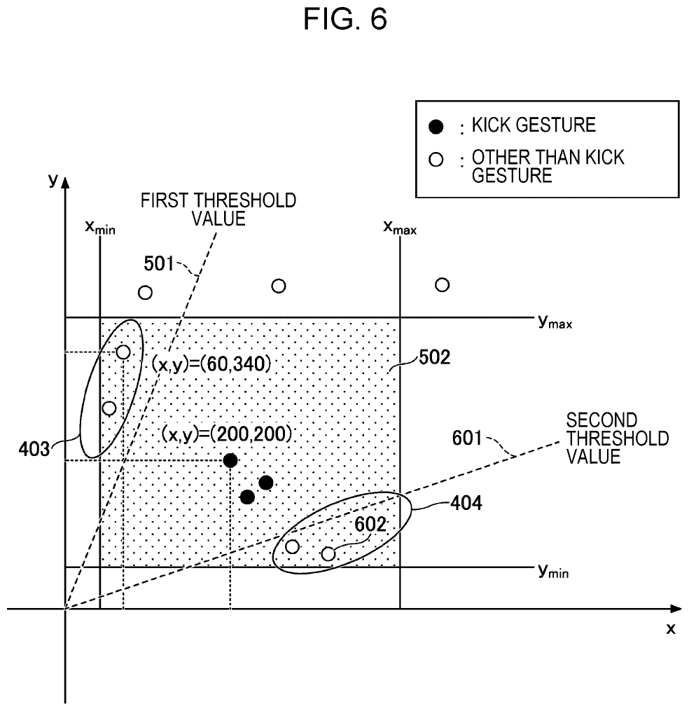

In this embodiment, preferably, as shown in FIG. 6, a second threshold value 601, which is used to determine whether a second distance ratio obtained by dividing a first distance x by a second distance y means a kick gesture or a gesture other than a kick gesture, is also used. In addition, the control unit 102 determines that a kick gesture has been performed when a first distance x is within the first distance range, a second distance y is within the second distance range, and a second distance ratio, which is obtained by dividing the first distance x by the second distance y, is less than the second threshold value 601. With this configuration, the control unit 102 can further reduce the occurrence of incorrect determination of data, for example, data 602 obtained by gestures other than kick gestures in the region 404 in FIG. 6 as kick gestures.

As described above, in the kick sensor 100 according to the embodiment that detects user's kick gestures, the occurrence of incorrect detection of gestures other than kick gestures as kick gestures can be reduced.

### <Hardware Configuration>

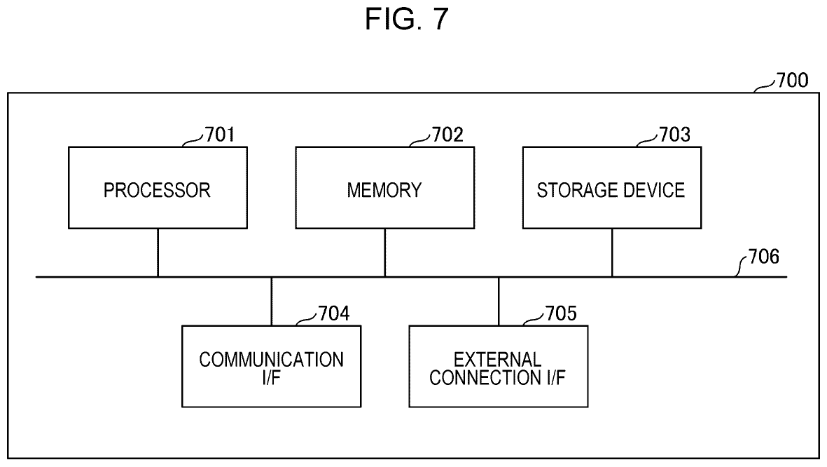

The control unit 102 of the kick sensor 100 and the electric control unit 12 have a hardware configuration like a computer 700 illustrated in FIG. 7. FIG. 7 is a diagram illustrating an example hardware configuration of the computer according to the embodiment. The computer 700 includes, for example, a processor 701, memory 702, a storage device 703, a communication interface (I/F) 704, an external connection I/F 705, a bus 706, and other elements.

The processor 701 is a computing device, such as a central processing unit (CPU) that implements various functions by executing a predetermined program stored in a storage medium such as the storage device 703, memory 702, or the like. The memory 702 includes, for example, random access memory (RAM) that is volatile memory used as a work area or the like for the processor 701, and read-only memory (ROM) that is nonvolatile memory used to store programs or the like for starting the processor 701. The storage device 703 is a large-capacity storage device that stores an operating system (OS), programs such as applications, and various data, information, or the like. The storage device 703 is implemented, for example, by a solid state drive (SSD), a hard disk drive (HDD), or the like.

The communication I/F 704 is an interface that connects the computer 700 to a communication network such as an in-vehicle network for communication with other devices. The external connection I/F 705 is an interface that connects an external device such as the sensor unit 101 to the computer 700. The bus 706 is commonly connected to each of the above-described elements and transmits, for example, address signals, data signals, and various control signals.

It should be noted that the hardware configuration of the computer 700 illustrated in FIG. 7 is an example. For example, the processor 701 may further include, in addition to the CPU, for example, a digital signal processor (DSP) or a graphics processing unit (GPU). The processor 701 may be implemented by a hardware device, for example, an application specific integrated circuit (ASIC), a field programmable gate array (FPGA), or the like. The computer 700 may be implemented by, for example, a micro controller unit (MCU), a System on a Chip (SoC), or the like.

### <Functional Configuration>

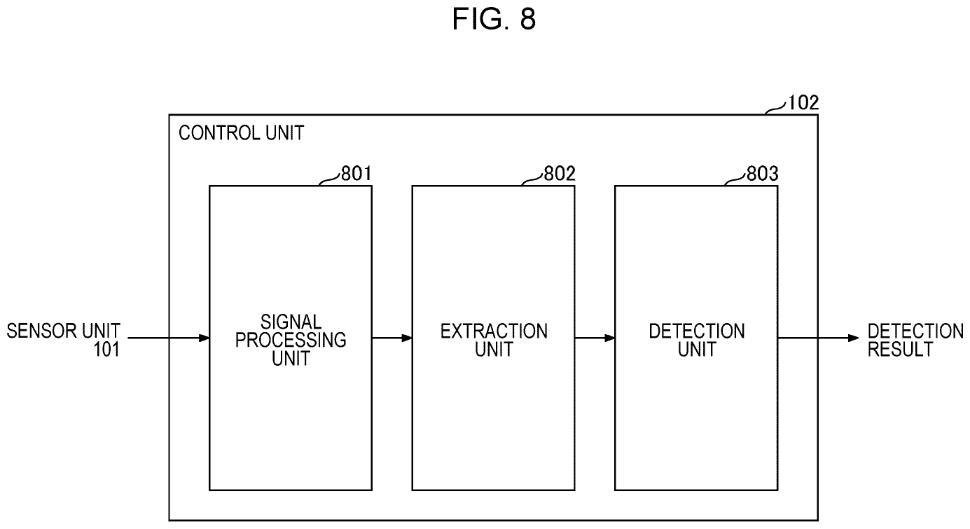

FIG. 8 is a diagram illustrating an example functional configuration of the control unit according to the embodiment. The control unit 102 of the kick sensor 100 implements a signal processing unit 801, an extraction unit 802, a detection unit 803, and other elements by, for example, executing a predetermined program by using the processor 701. It should be noted that at least some of the above functional configuration may be implemented by hardware.

The signal processing unit 801 performs signal processing to acquire a speed of a target object, an amplitude value of a received signal, and the like from the received signal output by the sensor unit 101. For example, when the sensor unit 101 is a radar, the signal processing unit acquires a received signal strength indicator (RSSI) that indicates the strength of the received signal as an amplitude value.

The extraction unit 802 extracts, from the speed of the target object output from the signal processing unit 801, a first distance x, which is a distance that the target object has moved toward the sensor unit 101, and a second distance y, which is a distance that the target object has moved away from the sensor unit 101. For example, the extraction unit 802 calculates the first distance x by accumulating the speed of the target object while the target object is moving toward the sensor unit 101, and calculates the second distance y by accumulating the speed of the target object while the target object is moving away from the sensor unit 101.

The extraction unit 802 stores (or outputs) a peak amplitude A of a received signal that is received from the start of the measurement of the first distance x to the end of the measurement of the second distance y.

A detection unit 803, based on the first distance x and the second distance y extracted by the extraction unit 802, detects a kick gesture. For example, the detection unit 803 determines that a kick gesture has been performed when the first distance x is within the first distance range, the second distance y is within the second distance range, and a first distance ratio y/x is less than the first threshold value 501, as described with reference to FIGS. 4 and 5.

Preferably, as described with reference to FIG. 6, the detection unit 803 further determines that a kick gesture has been performed when the first distance x is within the first distance range, the second distance y is within the second distance range, and a second distance ratio x/y is less than the second threshold value 601.

It should be noted that the functional configuration of the control unit 102 illustrated in FIG. 8 is an example. The control unit 102 may have any functional configuration as long as the above-described processing in the signal processing unit 801, the extraction unit 802, and the detection unit 803 can be executed.

### <Flow of Processing>

Next, a flow of processing in the method of detecting a kick gesture according to the embodiment will be described.

### <Kick Gesture Detection Process>

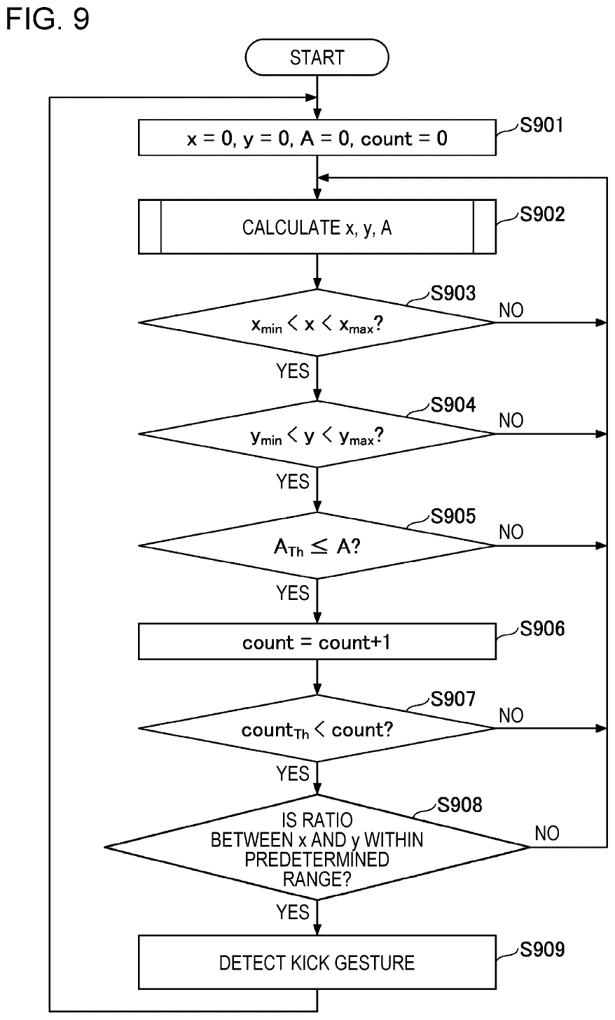

FIG. 9 is a flowchart illustrating an example of a kick gesture detection processing according to the embodiment. This processing is, for example, in the in-vehicle system 1 illustrated in FIG. 1, an example of the kick gesture detection processing performed by the control unit 102 of the kick sensor 100 that has the functional configuration illustrated in FIG. 8.

In step S901, the control unit 102 initializes a first distance x, a second distance y, a peak amplitude A, and a counter count. In step S902, the control unit 102 performs feature quantity extraction processing for calculating a first distance x, a second distance y, a peak amplitude A, and the like from a received signal output by the sensor unit 101. Specific detail of the feature quantity extraction processing will be described below.

In step S903, the control unit 102 determines whether the first distance x, which is a distance that the target object has moved toward the sensor unit 101, is within the first distance range described with reference to FIG. 4 (whether xₘᵢₙ<x<xₘₐₓ is satisfied). When the first distance x is within the first distance range, the control unit 102 goes to the processing in step S904. On the other hand, when the first distance x is not within the first distance range, the control unit 102 returns to the processing in step S902.

In step S904, the control unit 102 determines whether the second distance, which is a distance that the target object has moved away from the sensor unit 101, is within the second distance range described with reference to FIG. 4 (whether yₘᵢₙ<y<yₘₐₓ is satisfied). When the second distance y is within the second distance range, the control unit 102 goes to the processing in step S905. On the other hand, when the second distance y is not within the second distance range, the control unit 102 returns to the processing in step S902.

In step S905, the control unit 102 determines whether the peak amplitude A is greater than or equal to a predetermined value A_{Th} (whether A_{Th}≤A). Here, A_{Th} is a preset threshold value that is set to determine whether a received signal is noise or not.

When the peak amplitude A is greater than or equal to the predetermined value A_{Th}, the control unit 102 goes to the processing in step S906. On the other hand, when the peak amplitude A is not greater than or equal to the predetermined value A_{Th}, the control unit 102 determines that the received signal is noise, and return to the processing in step S902.

The processing in step S905 enables the control unit 102 to reduce the occurrence of incorrect determination of kick gestures caused by noise. For example, a first distance x and a second distance y equivalent to a kick gesture may be detected if radio waves reflected at the ground are further reflected at an object and return, or due to external radio waves caused by a radar or the like of another vehicle. However, most of the radio waves other than radio waves transmitted by the sensor unit 101 and directly reflected are weak in electric field strength. Accordingly, by the processing in step S905, kick gestures can be determined accurately based on the radio waves transmitted by the sensor unit 101 and directly reflected.

In steps S906 and S907, the control unit 102 adds one to the counter count, and determines whether the value of the counter count exceeds a predetermined value (count_{Th}) (whether count_{Th}<count). When the value of the counter count exceeds the predetermined value, the control unit 102 goes to the processing in step S908. On the other hand, when the value of the counter count does not exceed the predetermined value, the control unit 102 returns to the processing in step S902.

When the conditions that the first distance x is within the first distance range, and the second distance y is within the second distance range are satisfied in the processing in steps S906 and S907, after a predetermined time has passed, the control unit 102 starts the determination of a distance ratio between the first distance x and the second distance y.

If the determination is made immediately after both of the first distance x and the second distance y satisfy the conditions of the predetermined ranges, even if the target object moves at a high speed (too fast to be a kick gesture) and eventually satisfies y>yₘₐₓ, the gesture may be incorrectly determined as a kick gesture. In addition, when the target object moves while performing a kick gesture (e.g., moves backward immediately after a kick gesture), the speed does not become zero for some period of time even after the kick gesture ends. Accordingly, if the determination is made based on the condition that speed=0, the determination may be delayed.

To solve the above-described two problems, the control unit 102 starts the determination of the distance ratio between the first distance x and the second distance y after the conditions that the first distance x and the second distance y are within the predetermined ranges are satisfied respectively and then a predetermined time passes. In addition, the control unit 102 can adjust the predetermined time for a quick kick gesture to enable early kick gesture determination even if a quick kick gesture is performed. For example, the control unit 102 can start the determination and repeatedly perform the determination to enable accurate kick gesture determination even when a slow kick gesture is performed.

In step S908, the control unit 102 determines whether the distance ratio that is the ratio between the first distance x and the second distance y is within a predetermined range. For example, the control unit 102 determines whether the first distance ratio y/x obtained by dividing the second distance y by the first distance x is less than the first threshold value 501 described with reference to FIG. 5. In another example, the control unit 102 determines whether the first distance ratio y/x is less than the first threshold value 501 and the second distance ratio x/y obtained by dividing the first distance x by the second distance y is less than the second threshold value 601 described with reference to FIG. 6.

When the distance ratio that is the ratio between the first distance x and the second distance y is within the predetermined range, the control unit 102 goes to the processing in step S909. On the other hand, when the distance ratio that is the ratio between the first distance x and the second distance y is not within the predetermined range, the control unit 102 return the processing to step S902.

In step S909, the control unit 102 determines that a kick gesture has been performed, and outputs the detection result that indicates that a kick gesture has been detected to, for example, the electric control unit 12, and returns the processing to step S901. For example, the electric control unit 12 opens the rear door 11 of the vehicle 10 based on the detection result output by the control unit 102.

The processing in FIG. 9 enables the kick sensor 100 to reduce the occurrence of incorrect detection of gestures other than kick gestures as kick gestures.

### <Feature Quantity Extraction Process>

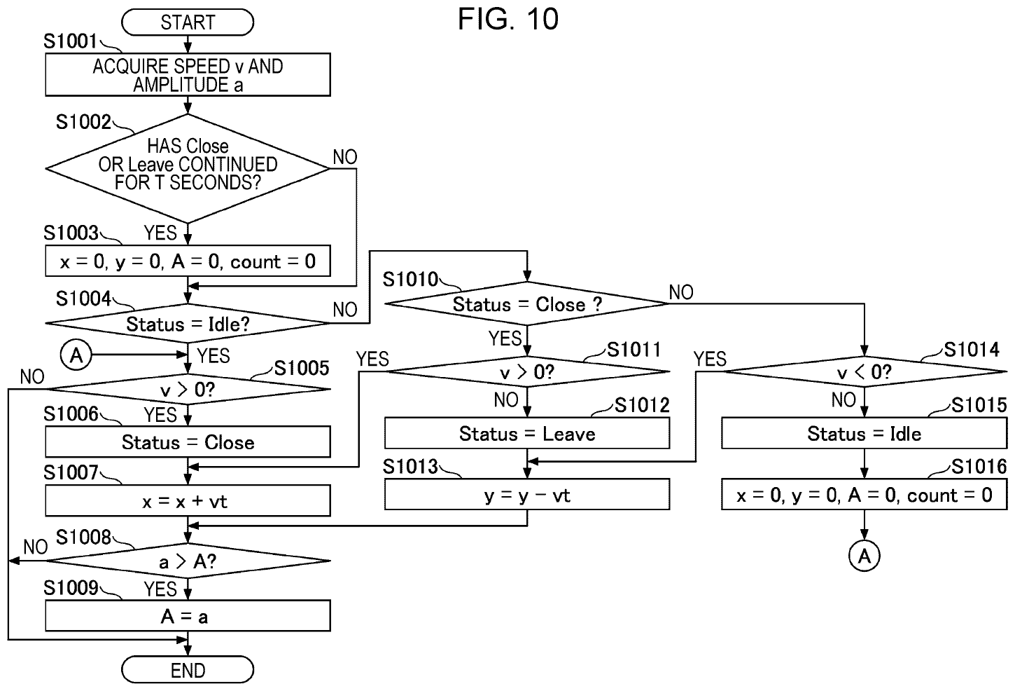

FIG. 10 is a flowchart illustrating an example of feature quantity extraction processing according to the embodiment. This processing, in step S902 in FIG. 9, is an example of the feature quantity extraction processing performed by the control unit 102 of the kick sensor 100. Here, the standby (S1) state described with reference to FIG. 2 is referred to as “Idle”, the approach (S2) state is referred to as “Close”, and the separation (S3) state is referred to as “Leave”.

In step S1001, the control unit 102 acquires, from the received signal output by the sensor unit 101, a speed v of the target object and an amplitude a of the received signal.

In step S1002, the control unit 102 determines whether Close (approach) or Leave (separation) has continued for T seconds. Here, T seconds is a preset duration T for resetting the first distance x and the second distance y when the target object continues to move toward the sensor unit 101 or the target object continues to move away from the sensor unit 101. By the processing described below, when the speed v of the target object v is a positive value, Status is set to Close. When the speed v of the target object v is a negative value, Status is set to Leave. In other words, the control unit 102 determines whether the duration of speed v>0 exceeds T or the duration of speed v<0 exceeds T.

When Close or Leave continues for T seconds, the control unit 102 goes to the processing in step S1003. On the other hand, when Close or Leave does not continue for T seconds, the control unit 102 goes to the processing in step S1004.

In step S1003, the control unit 102 initializes the first distance x, the second distance y, the peak amplitude A, and the value of counter count. In normal kick gestures, when a target object continues to move at an unnaturally slow speed, it is considered that a kick gesture has not started, and by initializing the values, the occurrence of incorrect determination of kick gestures by the control unit 102 can be reduced.

In step S1004, the control unit 102 determines whether Status that indicates the current state is Idle (standby) or not. When Status is Idle, the control unit 102 goes to the processing in step S1005. On the other hand, when Status is not Idle, the control unit 102 goes to the processing in step S1010.

In step S1005, the control unit 102 determines whether the speed v of the target object is greater than 0 (whether v>0). When the speed v is greater than 0, the control unit 102 goes to the processing in step S1006. On the other hand, when the speed v is less than or equal to 0, the control unit 102 ends the processing in FIG. 10.

In step S1006, the control unit 102 sets Status that indicates the current state to Close. In step S1007, the control unit 102 updates the first distance x by adding (speed v)× (execution cycle t) to the first distance x that the target object has moved toward the sensor unit 101.

In steps S1008 and S1009, the control unit 102 determines whether the acquired amplitude a is greater than the peak amplitude A, and when the amplitude a is greater than the peak amplitude A, updates the peak amplitude A to the value of the amplitude a.

When the processing proceeds from step S1004 to step S1010, the control unit 102 determines whether Status that indicates the current state is Close (approach) or not. When Status is Close, the control unit 102 goes to the processing in step S1011. On the other hand, when Status is not Close, the control unit 102 goes to the processing in step S1014.

In step S1011, the control unit 102 determines whether the speed v of the target object is greater than 0 (whether v>0). When the speed v is greater than 0, the control unit 102 goes to the processing in step S1007. On the other hand, when the speed v is less than or equal to 0, the control unit 102 goes to the processing in step S1012.

In step S1007, the control unit 102 updates the first distance x by adding (speed v) x (execution cycle t) to the first distance x that the target object has moved toward the sensor unit 101. In step S1012, the control unit 102 sets Status that indicates the current state to Leave.

In step S1013, the control unit 102 updates the second distance y by adding (speed v) x (execution cycle t) to the second distance y that the target object has moved away from the sensor unit 101, and goes to the processing in step S1008. It should be noted that, in this embodiment, in step S1013, to obtain a positive value for the second distance y, the values are calculated by using a subtraction formula. However, when y=y+vt is used for the equation in step S1013, the same determination result can be obtained by changing the sign of the threshold value or the direction of the inequality in the determination expression described below.

When the processing proceeds from step S1010 to step S1014, the control unit 102 determines whether the speed v of the target object is less than 0 (whether v<0). At this time, Status that indicates the current state is neither Idle nor Close, and Status is Leave. When the speed v is less than 0, the control unit 102 goes to the processing in step S1013. In step S1013, the control unit 102 updates the second distance y by adding (speed v)× (execution cycle t) to the second distance y that the target object has moved away from the sensor unit 101. On the other hand, when the speed v is greater than or equal to 0, the control unit 102 goes to the processing in step S1015.

In step S1015, the control unit 102 sets Status that indicates the current state to Idle. In step S1016, the control unit 102 initializes the first distance x, the second distance y, the peak amplitude A, and the counter count, and goes to the processing in step S1005.

By the processing in FIG. 10, the control unit 102 of the kick sensor 100 can calculate the first distance x, the second distance y, the peak amplitude A, and the like from the received signal output by the sensor unit 101.

### <Distance Ratio Determination Process>

Here, variations of the distance ratio determination processing in step S908 in FIG. 9 will be described. In the processing, the control unit 102 of the kick sensor 100 determines whether the distance ratio between the first distance x and the second distance y is within a predetermined range.

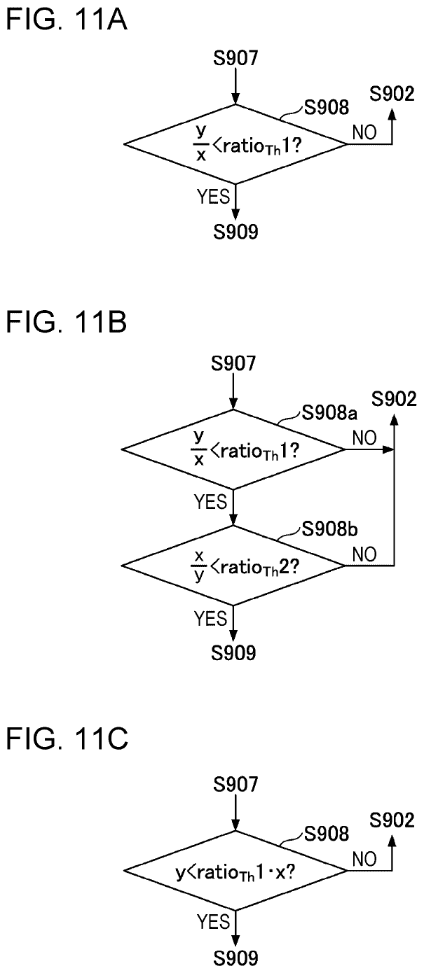

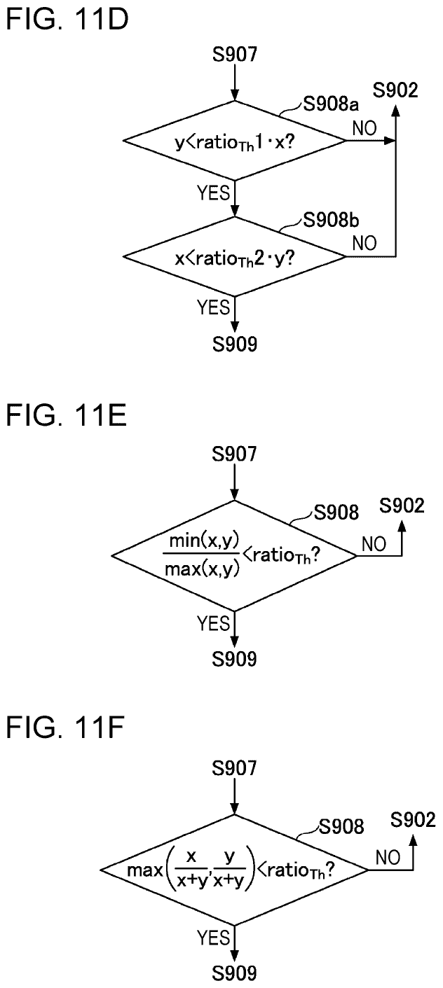

As an example, in step S908 in FIG. 9, as illustrated in FIG. 11A, the control unit 102 determines whether the first distance ratio y/x obtained by dividing the second distance y by the first distance x is less than the first threshold value ratio_{Th}1 described with reference to FIG. 5. When the first distance ratio y/x is less than the first threshold value ratio_{Th}1, the control unit 102 determines that the distance ratio between the first distance x and the second distance y is within the predetermined range, and the control unit 102 goes to the processing in step S909. On the other hand, when the first distance ratio y/x is not less than the first threshold value ratio_{Th}1, the control unit 102 determines that the distance ratio between the first distance x and the second distance y is not within the predetermined range, and returns to the processing in step S902. By the processing, when the second distance y is excessively large to the first distance x, the control unit 102 can determine that the gesture is not a kick gesture.

In another example, in step S908 in FIG. 9, as illustrated in FIG. 11B, the control unit 102 may perform processing in steps S908a and S908b. In step S908a, the control unit 102 determines whether the first distance ratio y/x is less than the first threshold value ratio_{Th}1 described with reference to FIG. 5. When the first distance ratio y/x is less than the first threshold value ratio_{Th}1, the control unit 102 goes to the processing in step S908b. On the other hand, when the first distance ratio y/x is not less than the first threshold value ratio_{Th}1, the control unit 102 return the processing to the processing in step S902.

In step S908b, the control unit 102 determines whether the second distance ratio x/y obtained by dividing the first distance x by the second distance y is less than the second threshold value ratio_{Th}2 described with reference to FIG. 2. When the second distance ratio x/y is less than the second threshold value ratio_{Th}2, the control unit 102 determines that the distance ratio between the first distance x and the second distance y is within the predetermined range, and the control unit 102 goes to the processing in step S909. On the other hand, when the second distance ratio x/y is not less than the second threshold value ratio_{Th}2, the control unit 102 determines that the distance ratio between the first distance x and the second distance y is not within the predetermined range, and returns to the processing in step S902. By the processing, when the first distance x is excessively large to the second distance y, the control unit 102 can determine that the gesture is not a kick gesture.

The kick sensor 100 is designed on the assumption that a user performs a kick gesture while approaching, and the position of the user's leg after the user kicks upward is expected to be closer to the kick sensor 100 than the position of the leg before the user kicks upward. In this case, it is preferable that the first threshold ratio_{Th}1 be smaller than the second threshold value ratio_{Th}2.

On the other hand, in a case of the kick sensor 100 that is designed on the assumption that a user stops and performs a kick gesture, the position of the user's leg before the user kicks upward and the position of the user's leg after the user brings the user's leg back are almost the same, and it is preferable that the first threshold value ratio_{Th}1 and the second threshold value ratio_{Th}2 be equal values.

In another example, in a case of the kick sensor 100 that is designed to open the rear door of the vehicle, it is assumed that a user moves rearward after the user performs a kick gesture, and it is preferable that the first threshold value ratio_{Th}1 be larger than the second threshold value ratio_{Th}2.

FIG. 11C illustrates a modification of the processing in FIG. 11A. The control unit 102 may, for example, as illustrated in FIG. 11C, instead of calculating y/x, compare the relationship between the first threshold value ratio_{Th}1 multiplied by x and the second distance y to substantially determine whether the first distance ratio y/x is less than the first threshold value ratio_{Th}1.

Similarly, FIG. 11D illustrates a modification of the processing in FIG. 11B. The control unit 102 may, for example, as illustrated in FIG. 11D, instead of calculating x/y, compare the relationship between the second threshold value ratio_{Th}2 multiplied by y and the first distance x to substantially determine whether the second distance ratio x/y is less than the second threshold value ratio_{Th}2.

When the first threshold value ratio_{Th}1 and the second threshold value ratio_{Th} 2 are equal, as illustrated in FIG. 11E, the control unit 102 may determine whether the distance ratio between the first distance x and the second distance y is within the predetermined range by using the following Equation (1).

$$\frac{min ( x , y )}{max ( x , y )} > {ratio}_{Th} \qquad Equation ( 1 )$$

In this case, when the distance ratio is greater than or equal to the threshold value, the control unit 102 determines that a kick gesture has been performed. It should be noted that y/x<constant is equivalent to x/y>constant, and x/y<constant is equivalent to y/x>constant (the values of the constants are different).

Alternatively, as illustrated in FIG. 11F, the control unit 102 may determine whether the distance ratio between the first distance x and the second distance y is within the predetermined range by using the following Equation (2).

$$max ( \frac{x}{x + y} , \frac{y}{x + y} ) < {ratio}_{Th} \qquad Equation ( 2 )$$

In step S908 in FIG. 9, when the control unit 102 determines whether the distance ratio between the first distance x and the second distance y is within a predetermined range, the control unit 102 does not necessarily calculate the first distance ratio y/x or the second distance ratio x/y.

As described above, in the kick sensor according to the embodiment that detects user's kick gestures, the occurrence of incorrect detection of gestures other than kick gestures as kick gestures can be reduced.

In addition, the vehicle 10 provided with the kick sensor 100 according to the embodiment can reduce the occurrence of incorrect opening and closing of the doors of the vehicle 10 in response to gestures other than kick gestures.

It is to be understood that the present invention is not limited to the above-described embodiments, and various modifications or applications may be made within the scope of the following claims.

What is claimed is:

1. A kick sensor comprising:
a sensor unit disposed to a vehicle to detect approach and separation of a target object; and
a control unit configured to determine motion of the target object based on a detection result of the sensor unit, wherein
the control unit
calculates a first distance that the target object has moved toward the sensor unit and a second distance that the target object has moved away from the sensor unit, and
determines that a kick gesture has been performed when the first distance is within a first distance range, the second distance is within a second distance range, and a first distance ratio obtained by dividing the second distance by the first distance is less than a first threshold value.

2. The kick sensor according to claim 1, wherein when the conditions that the first distance is within the first distance range and the second distance is within the second distance range are satisfied, and after a predetermined time has passed, the control unit starts the determination of the first distance ratio.

3. The kick sensor according to claim 1, wherein
the sensor unit transmits a signal and measures an amplitude of a received signal that is reflected at the target object and received, and
the control unit
stores a peak amplitude of the received signal that is received from the start of the measurement of the first distance to the end of the measurement of the second distance, and
when the peak amplitude is less than a predetermined value, determines that the kick gesture has not been performed.

4. The kick sensor according to claim 1, wherein
the sensor unit includes a Doppler radar, and
the control unit
accumulates a speed of the target object while the target object is moving toward the sensor unit and calculates the first distance, and
accumulates a speed of the target object while the target object is moving away from the sensor unit and calculates the second distance.

5. The kick sensor according to claim 1, wherein
the control unit determines that a kick gesture has been performed when the first distance is within the first distance range, the second distance is within the second distance range, and a second distance ratio obtained by dividing the first distance by the second distance is less than a second threshold value.

6. The kick sensor according to claim 5, wherein the first threshold value is smaller than the second threshold value.

7. The kick sensor according to claim 5, wherein the first threshold value and the second threshold value are equal.

8. The kick sensor according to claim 5, wherein the first threshold value is larger than the second threshold value.

9. The kick sensor according to claim 1, wherein a lower limit value of the first distance range is smaller than a lower limit value of the second distance range.

10. The kick sensor according to claim 1, wherein an upper limit value of the first distance range is larger than an upper limit value of the second distance range.

11. The kick sensor according to claim 1, wherein
the control unit
measures a duration the target object continues to move toward the sensor unit or a duration the target object continues to move away from the sensor unit, and
When the duration exceeds a predetermined time, resets the first distance and the second distance.

12. A vehicle comprising the kick sensor according to claim 1.

13. A method of detecting a kick gesture by using a kick sensor, the kick sensor comprising:
a sensor unit disposed to a vehicle to detect approach and separation of a target object; and
a control unit configured to determine motion of the target object based on a detection result of the sensor unit, wherein
the control unit
calculates a first distance that the target object has moved toward the sensor unit and a second distance that the target object has moved away from the sensor unit, and
determines that the kick gesture has been performed when the first distance is within a first distance range, the second distance is within a second distance range, and a first distance ratio obtained by dividing the second distance by the first distance is less than a first threshold value.
